(19) United States
(12) Patent Application Publication
(10) Pub. No.: US 2020/0019295 A1
(43) Pub. Date: Jan. 16, 2020

(54) Systems and Methods To Administer a Chat Session In An Augmented Reality Environment

(71) Applicant: Magical Technologies, LLC, Redmond, WA (US)

(72) Inventors: Nova Spivack, REDMOND, WA (US); Matthew Hoerl, REDMOND, WA (US)

(21) Appl. No.: 16/511,186

(22) Filed: Jul. 15, 2019

Related U.S. Application Data
(60) Provisional application No. 62/698,179, filed on Jul. 15, 2018.

(51) Int. Cl. G06F 3/0481; G06F 3/14; G06F 3/01; G06T 19/00

(52) U.S. Cl. CPC G06F 3/04815; G06T 19/006; G06F 3/011; G06F 3/1454

(57) ABSTRACT

Systems, methods to administer a chat session in an AR environment are disclosed. In one aspect, embodiments of the present disclosure include a method, which may be implemented on a system, to causing to be perceptible, by a recipient user of the augmented reality environment, a virtual object in an augmented reality chat stream, such that the recipient user is able to engage in the chat session. The virtual object can be presented in a first rendering in the augmented reality chat stream of the augmented reality environment. The method can further include responsive to detecting that an action has been performed on the virtual object by the recipient user, generating a second rendering of the virtual object and/or depicting the second rendering of the virtual object in the chat stream.

### CLAIM OF PRIORITY

This application claims the benefit of:
U.S. Provisional Application No. 62/698,179, filed Jul. 15, 2018 and entitled “Systems, Methods and Apparatuses of Augmented Reality Enhanced and Interactive Stories, Messages and Profiles,” (8011.US00), the contents of which are incorporated by reference in their entirety.

### RELATED APPLICATIONS

This application is related to PCT Application no. PCT/US2018/44844, filed Aug. 1, 2018 and entitled “Systems, Methods and Apparatuses to Facilitate Trade or Exchange of Virtual Real-Estate Associated with a Physical Space” (Attorney Docket No. 99005-8002.WO01), the contents of which are incorporated by reference in their entirety.

This application is related to PCT Application no. PCT/US2018/45450, filed Aug. 6, 2018 and entitled “Systems, Methods and Apparatuses for Deployment and Targeting of Context-Aware Virtual Objects and/or Objects and/or Behavior Modeling of Virtual Objects Based on Physical Principles” (Attorney Docket No. 99005-8003.WO01), the contents of which are incorporated by reference in their entirety.

This application is related to PCT Application no. PCT/US2018/50952, filed on Sep. 13, 2018 and entitled “Systems And Methods Of Shareable Virtual Objects and Virtual Objects As Message Objects To Facilitate Communications Sessions In An Augmented Reality Environment” (Attorney Docket No. 99005-8004.WO01), the contents of which are incorporated by reference in their entirety.

This application is related to PCT Application No. PCT/US2018/56951, filed Oct. 22, 2018 and entitled “Systems, methods and apparatuses of digital assistants in an augmented reality environment and local determination of virtual object placement and apparatuses of single or multi-directional lens as portals between a physical world and a digital world component of the augmented reality environment” (8005.WO01), the contents of which are incorporated by reference in their entirety.

This application is related to PCT Application No. PCT/US2019/_____ , filed Jul. 15, 2019 and entitled “Systems and Methods to Administer a Chat Session In An Augmented Reality Environment” (8011.WO01), the contents of which are incorporated by reference in their entirety.

### TECHNICAL FIELD

The disclosed technology relates generally to systems, methods and apparatuses of: creating, provisioning, and/or generating message objects with digital enhancements. The enhanced messages can include virtual or augmented reality features, components or portions.

### BACKGROUND

The advent of the World Wide Web and its proliferation in the 90′s transformed the way humans conduct business, personal lives, consume/communicate information and interact with or relate to others. A new wave of technology is on the cusp of the horizon to revolutionize our already digitally immersed lives.

### BRIEF DESCRIPTION OF THE DRAWINGS

FIG. 1 illustrates an example block diagram of a host server able to administer a chat session in an augmented reality (AR) environment, in accordance with embodiments of the present disclosure.

FIG. 2A depicts an example of a user interface of a chat stream showing thumbnails for chat bubbles that have been accessed, in accordance with embodiments of the present disclosure.

FIG. 2B depicts an example of a user interface of a profile virtual object and a virtual item having multiple virtual objects, in accordance with embodiments of the present disclosure.

FIG. 2C depicts an example of a user interface of showing indicators associated with virtual reality backgrounds in a tool belt in the AR environment, in accordance with embodiments of the present disclosure.

FIG. 2D depicts an example of a further user interface of an augmented reality story object, in accordance with embodiments of the present disclosure.

FIG. 3A depicts an example functional block diagram of a host server that administers a chat session in an AR environment, in accordance with embodiments of the present disclosure.

FIG. 3B depicts an example block diagram illustrating the components of the host server that administers a chat session in an AR environment, in accordance with embodiments of the present disclosure

FIG. 4A depicts an example functional block diagram of a client device such as a mobile device that enables participations in a chat session in an AR environment, in accordance with embodiments of the present disclosure

FIG. 4B depicts an example block diagram of the client device, which can be a mobile device that enables participations in a chat session in an AR environment, in accordance with embodiments of the present disclosure.

FIG. 5A graphically depicts a diagrammatic example of an application browser view to access virtual items, in accordance with embodiments of the present disclosure.

FIG. 5B-5C graphically depict diagrammatic examples of a virtual item in the AR environment, in accordance with embodiments of the present disclosure.

FIG. 6A-6B graphically depict multidimensional user interfaces for facilitating user interaction, in accordance with embodiments of the present disclosure.

FIG. 7A-7B depict flow charts illustrating an example process to render an AR chat stream in the AR environment, in accordance with embodiments of the present disclosure.

FIG. 8 depicts a flow chart illustrating an example process to change the virtual reality background among which multiple virtual objects are depicted, in accordance with embodiments of the present disclosure.

FIG. 9 is a block diagram illustrating an example of a software architecture that may be installed on a machine, in accordance with embodiments of the present disclosure.

FIG. 10 is a block diagram illustrating components of a machine, according to some example embodiments, able to read a set of instructions from a machine-readable medium (e.g., a machine-readable storage medium) and perform any one or more of the methodologies discussed herein.

### DETAILED DESCRIPTION

The following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but not necessarily are, references to the same embodiment; and, such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that the same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Embodiments of the present disclosure include systems and methods for adjusting levels of perceptibility of user-perceivable content/information via a platform which facilitates user interaction with objects in a digital environment. Aspects of the present disclosure include techniques to control or adjust various mixtures of perceptibility, in a digital environment, between the real world objects/content/environment and virtual objects/content/environment. Embodiments of the present disclosure further include control or adjustment of relative perceptibility between real things (e.g., real world objects/content/environment) and virtual things (e.g., virtual objects/content/environment).

The innovation includes for example, techniques to control or adjust various mixtures of perceptibility, in a digital environment, between the real world objects/content/environment and virtual objects/content/environment.

Digital Objects

The digital objects presented by the disclosed system in a digital environment, can, for instance, include:

a) ‘virtual objects’ which can include any computer generated, computer animated, digitally rendered/reproduced, artificial objects/environment and/or synthetic objects/environment. Virtual objects need not have any relation or context to the real world or its phenomena or its object places or things. Virtual objects generally also include the relative virtual objects or ‘simulated objects’ as described below in b).

b) ‘Relative virtual objects’ or also referred to as ‘simulated objects’ can generally include virtual objects/environments that augment or represent real objects/environments of the real world. Relative virtual objects (e.g., simulated objects) generally further include virtual objects that are temporally or spatially relevant and/or has any relation, relevance, ties, correlation, anti-correlation, context to real world phenomenon, concepts or its objects, places, persons or things; ‘relative virtual objects’ or ‘simulated objects’ can also include or have relationships to, events, circumstances, causes, conditions, context, user behavior or profile or intent, nearby things, other virtual objects, program state, interactions with people or virtual things or physical things or real or virtual environments, real or virtual physical laws, game mechanics, rules. In general ‘relative virtual objects’ can include any digital object that appears, disappears, or is generated, modified or edited based on any of the above factors.

c) ‘Reality objects’ or ‘basic reality objects’ which can perceptibly (e.g., visually or audibly) correspond to renderings or exact/substantially exact reproductions of reality itself. Reality includes tangibles or intangible in the real world. Such renderings or reproductions can include by way of example, an image, a (screenshot) shot, photo, video, live stream of a physical scene and/or its visible component or recordings or (live) stream of an audible component, e.g., sound of an airplane, traffic noise, Niagara falls, birds chirping.

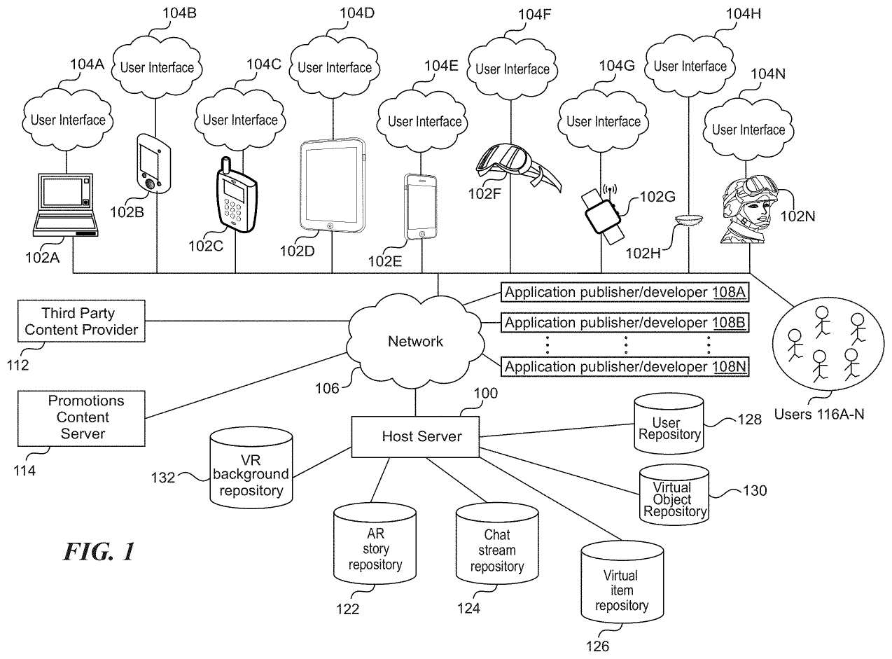

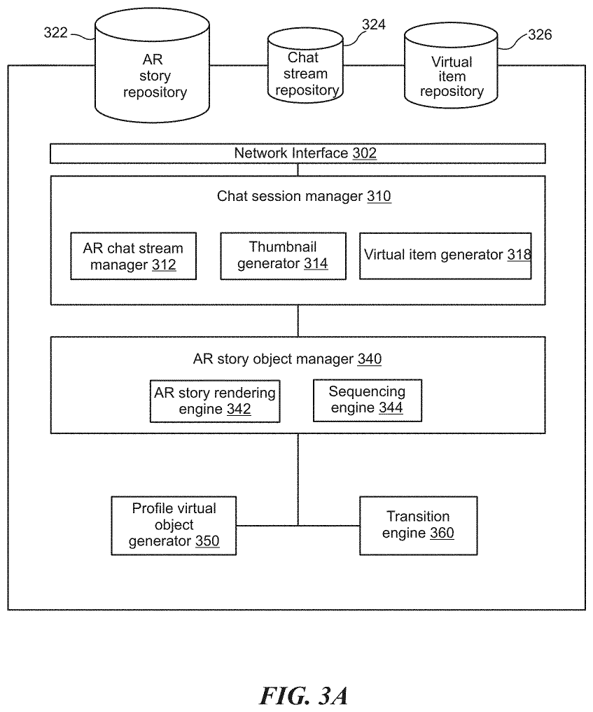

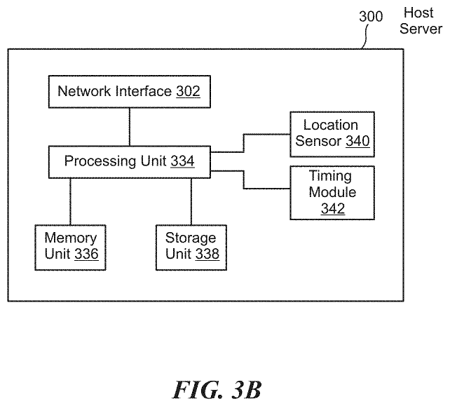

The disclosed system (e.g. host server 100 of FIG. 1 and/or host server 300 of FIG. 3A-3B) can depict/present/augment, via a user device any combination/mixture of: virtual objects (including ‘relative virtual objects’) and reality objects (or, also referred to as ‘basic reality objects’). Any mixture of such objects can be depicted in a digital environment (e.g., via visible area or user-perceptible area on a display or device, or a projection in the air/space).

Embodiments of the present disclosure further enable and facilitate adjustment and selection of the level/degree of perceptibility amongst the objects of varying levels of ‘virtualness.’ by a user, by a system, a platform or by any given application/software component in a given system.

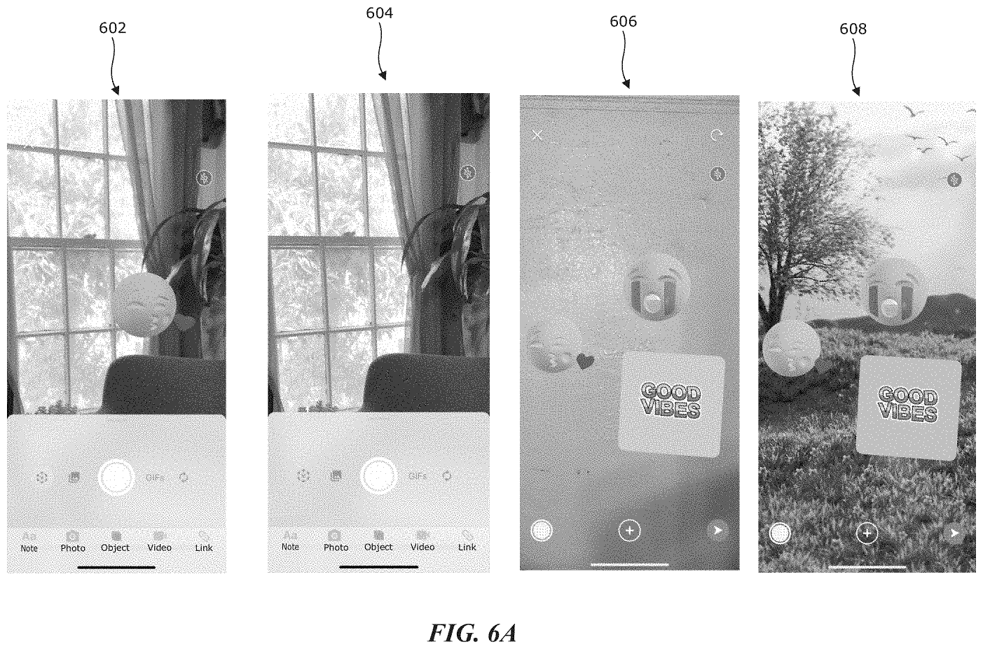

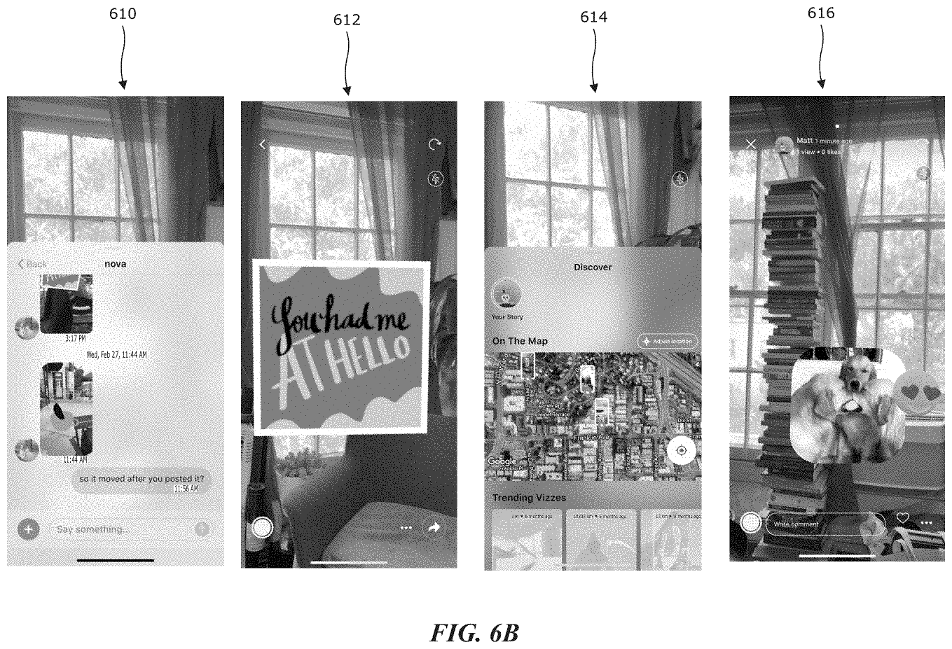

Specifically, innovative aspects of the present disclosure include facilitating selection or adjustment of perceptibility (human perceptibility) amongst the virtual objects, reality objects, and/or relative virtual objects (e.g., simulated objects) in a digital environment (e.g., for any given scene or view). This adjustment and selection mechanism(e.g., via the user controls shown in the examples of FIG. 6A-6B) affects the virtualness of any given digital environment, with increased perceptibility of virtual objects generally corresponding to a higher virtualness level, with decreased perceptibility of virtual objects corresponding to a lower virtualness level. Similarly, decreased perceptibility of reality objects corresponds to increased virtualness and increased perceptibility of reality objects corresponds generally to decreased virtualness.

In one example embodiment of the present disclosure, opacity is used to adjust various components or objects in a digital environment can be thought of or implemented as a new dimension in a platform or user interface like window size and window location.

Embodiments of the present disclosure include systems, methods and apparatuses of platforms (e.g., as hosted by the host server 100 as depicted in the example of FIG. 1) for deployment and targeting of context-aware virtual objects and/or behavior modeling of virtual objects based on physical laws or principle. Further embodiments relate to how interactive virtual objects that correspond to content or physical objects in the physical world are detected and/or generated, and how users can then interact with those virtual objects, and/or the behavioral characteristics of the virtual objects, and how they can be modeled. Embodiments of the present disclosure further include processes that augmented reality data (such as a label or name or other data) with media content, media content segments (digital, analog, or physical) or physical objects. Yet further embodiments of the present disclosure include a platform (e.g., as hosted by the host server 100 as depicted in the example of FIG. 1) to provide an augmented reality (AR) workspace in a physical space, where a virtual object can be rendered as a user interface element of the AR workspace.

Embodiments of the present disclosure further include systems, methods and apparatuses of platforms (e.g., as hosted by the host server 100 as depicted in the example of FIG. 1) for managing and facilitating transactions or other activities associated with virtual real-estate (e.g., or digital real-estate). In general, the virtual or digital real-estate is associated with physical locations in the real world. The platform facilitates monetization and trading of a portion or portions of virtual spaces or virtual layers (e.g., virtual real-estate) of an augmented reality (AR) environment (e.g., alternate reality environment, mixed reality (MR) environment) or virtual reality VR environment.

In an augmented reality environment (AR environment), scenes or images of the physical world is depicted with a virtual world that appears to a human user, as being superimposed or overlaid of the physical world. Augmented reality enabled technology and devices can therefore facilitate and enable various types of activities with respect to and within virtual locations in the virtual world. Due to the inter connectivity and relationships between the physical world and the virtual world in the augmented reality environment, activities in the virtual world can drive traffic to the corresponding locations in the physical world. Similarly, content or virtual objects (VOBs) associated with busier physical locations or placed at certain locations (e.g., eye level versus other levels) will likely have a larger potential audience.

By virtual of the inter-relationship and connections between virtual spaces and real world locations enabled by or driven by AR, just as there is a value to real-estate in the real world locations, there can be inherent value or values for the corresponding virtual real-estate in the virtual spaces. For example, an entity who is a right holder (e.g., owner, renter, sub-lettor, licensor) or is otherwise associated a region of virtual real-estate can control what virtual objects can be placed into that virtual real-estate.

The entity that is the rightholder of the virtual real-state can control the content or objects (e.g., virtual objects) that can be placed in it, by whom, for how long, etc. As such, the disclosed technology includes a marketplace (e.g., as run by server 100 of FIG. 1) to facilitate exchange of virtual real-estate (VRE) such that entities can control object or content placement to a virtual space that is associated with a physical space.

Embodiments of the present disclosure further include systems, methods and apparatuses of seamless integration of augmented, alternate, virtual, and/or mixed realities with physical realities for enhancement of web, mobile and/or other digital experiences. Embodiments of the present disclosure further include systems, methods and apparatuses to facilitate physical and non-physical interaction/action/reactions between alternate realities. Embodiments of the present disclosure also systems, methods and apparatuses of multidimensional mapping of universal locations or location ranges for alternate or augmented digital experiences. Yet further embodiments of the present disclosure include systems, methods and apparatuses to create real world value and demand for virtual spaces via an alternate reality environment.

The disclosed platform enables and facilitates authoring, discovering, and/or interacting with virtual objects (VOBs). One example embodiment includes a system and a platform that can facilitate human interaction or engagement with virtual objects (hereinafter, ‘VOB,’ or ‘VOBs’) in a digital realm (e.g., an augmented reality environment (AR), an alternate reality environment (AR), a mixed reality environment (MR) or a virtual reality environment (VR)). The human interactions or engagements with

VOBs in or via the disclosed environment can be integrated with and bring utility to everyday lives through integration, enhancement or optimization of our digital activities such as web browsing, digital (online, or mobile shopping) shopping, socializing (e.g., social networking, sharing of digital content, maintaining photos, videos, other multimedia content), digital communications (e.g., messaging, emails, SMS, mobile communication channels, etc.), business activities (e.g., document management, document procession), business processes (e.g., IT, HR, security, etc.), transportation, travel, etc.

The disclosed innovation provides another dimension to digital activities through integration with the real world environment and real world contexts to enhance utility, usability, relevancy, and/or entertainment or vanity value through optimized contextual, social, spatial, temporal awareness and relevancy. In general, the virtual objects depicted via the disclosed system and platform. can be contextually (e.g., temporally, spatially, socially, user-specific, etc.) relevant and/or contextually aware. Specifically, the virtual objects can have attributes that are associated with or relevant real world places, real world events, humans, real world entities, real world things, real world objects, real world concepts and/or times of the physical world, and thus its deployment as an augmentation of a digital experience provides additional real life utility.

Note that in some instances, VOBs can be geographically, spatially and/or socially relevant and/or further possess real life utility. In accordance with embodiments of the present disclosure, VOBs can be or appear to be random in appearance or representation with little to no real world relation and have little to marginal utility in the real world. It is possible that the same VOB can appear random or of little use to one human user while being relevant in one or more ways to another user in the AR environment or platform.

The disclosed platform enables users to interact with VOBs and deployed environments using any device (e.g., devices 102A-N in the example of FIG. 1), including by way of example, computers, PDAs, phones, mobile phones, tablets, head mounted devices, goggles, smart watches, monocles, smart lens, smart watches and other smart apparel (e.g., smart shoes, smart clothing), and any other smart devices.

In one embodiment, the disclosed platform includes an information and content in a space similar to the World Wide Web for the physical world. The information and content can be represented in 3D and or have 360 or near 360 degree views. The information and content can be linked to one another by way of resource identifiers or locators. The host server (e.g., host server 100 as depicted in the example of FIG. 1) can provide a browser, a hosted server, and a search engine, for this new Web.

Embodiments of the disclosed platform enables content (e.g., VOBs, third party applications, AR-enabled applications, or other objects) to be created and placed into layers (e.g., components of the virtual world, namespaces, virtual world components, digital namespaces, etc.) that overlay geographic locations by anyone, and focused around a layer that has the highest number of audience (e.g., a public layer). The public layer can in some instances, be the main discovery mechanism and source for advertising venue for monetizing the disclosed platform.

In one embodiment, the disclosed platform includes a virtual world that exists in another dimension superimposed on the physical world. Users can perceive, observe, access, engage with or otherwise interact with this virtual world via a user interface (e.g., user interface 104A-N as depicted in the example of FIG. 1) of client application (e.g., accessed via using a user device, such as devices 102A-N as illustrated in the example of FIG. 1).

One embodiment of the present disclosure includes a consumer or client application component (e.g., as deployed on user devices, such as user devices 102A-N as depicted in the example of FIG. 1) which is able to provide geo-contextual awareness to human users of the AR environment and platform. The client application can sense, detect or recognize virtual objects and/or other human users, actors, non-player characters or any other human or computer participants that are within range of their physical location, and can enable the users to observe, view, act, interact, react with respect to the VOBs.

Furthermore, embodiments of the present disclosure further include an enterprise application (which can be desktop, mobile or browser based application). In this case, retailers, advertisers, merchants or third party e-commerce platforms/sites/providers can access the disclosed platform through the enterprise application which enables management of paid advertising campaigns deployed via the platform.

Users (e.g., users 116A-N of FIG. 1) can access the client application which connects to the host platform (e.g., as hosted by the host server 100 as depicted in the example of FIG. 1). The client application enables users (e.g., users 116A-N of FIG. 1) to sense and interact with virtual objects (“VOBs”) and other users (“Users”), actors, non-player characters, players, or other participants of the platform. The VOBs can be marked or tagged (by QR code, other bar codes, or image markers) for detection by the client application.

One example of an AR environment deployed by the host (e.g., the host server 100 as depicted in the example of FIG. 1) enables users to interact with virtual objects (VOBs) or applications related to shopping and retail in the physical world or online/e-commerce or mobile commerce. Retailers, merchants, commerce/e-commerce platforms, classified ad systems, and other advertisers will be able to pay to promote virtual objects representing coupons and gift cards in physical locations near or within their stores. Retailers can benefit because the disclosed platform provides a new way to get people into physical stores. For example, this can be a way to offer VOBs can are or function as coupons and gift cards that are available or valid at certain locations and times.

Additional environments that the platform can deploy, facilitate, or augment can include for example AR-enabled games, collaboration, public information, education, tourism, travel, dining, entertainment etc.

The seamless integration of real, augmented and virtual for physical places/locations in the universe is a differentiator. In addition to augmenting the world, the disclosed system also enables an open number of additional dimensions to be layered over it and, some of them exist in different spectra or astral planes. The digital dimensions can include virtual worlds that can appear different from the physical world. Note that any point in the physical world can index to layers of virtual worlds or virtual world components at that point. The platform can enable layers that allow non-physical interactions.

FIG. 1 illustrates an example block diagram of a host server 100 able to administer a chat session in an augmented reality (AR) environment, in accordance with embodiments of the present disclosure.

The client devices 102A-N can be any system and/or device, and/or any combination of devices/systems that is able to establish a connection with another device, a server and/or other systems. Client devices 102A-N each typically include a display and/or other output functionalities to present information and data exchanged between among the devices 102A-N and the host server 100.

For example, the client devices 102A-N can include mobile, hand held or portable devices or non-portable devices and can be any of, but not limited to, a server desktop, a desktop computer, a computer cluster, or portable devices including, a notebook, a laptop computer, a handheld computer, a palmtop computer, a mobile phone, a cell phone, a smart phone, a PDA, a Blackberry device, a Treo, a handheld tablet (e.g. an iPad, a Galaxy, Xoom Tablet, etc.), a tablet PC, a thin-client, a hand held console, a hand held gaming device or console, an iPhone, a wearable device, a head mounted device, a smart watch, a goggle, a smart glasses, a smart contact lens, and/or any other portable, mobile, hand held devices, etc. The input mechanism on client devices 102A-N can include touch screen keypad (including single touch, multi-touch, gesture sensing in 2D or 3D, etc.), a physical keypad, a mouse, a pointer, a track pad, motion detector (e.g., including 1-axis, 2-axis, 3-axis accelerometer, etc.), a light sensor, capacitance sensor, resistance sensor, temperature sensor, proximity sensor, a piezoelectric device, device orientation detector (e.g., electronic compass, tilt sensor, rotation sensor, gyroscope, accelerometer), eye tracking, eye detection, pupil tracking/detection, or a combination of the above.

The client devices 102A-N, application publisher/developer 108A-N, its respective networks of users, a third party content provider 112, and/or promotional content server 114, can be coupled to the network 106 and/or multiple networks. In some embodiments, the devices 102A-N and host server 100 may be directly connected to one another. The alternate, augmented provided or developed by the application publisher/developer 108A-N can include any digital, online, web-based and/or mobile based environments including enterprise applications, entertainment, games, social networking, e-commerce, search, browsing, discovery, messaging, chatting, and/or any other types of activities (e.g., network-enabled activities).

In one embodiment, the host server 100 is operable to administer a chat session in an augmented reality (AR) environment (e.g., as depicted or deployed via user devices 102A-N). The host server 100 can transmit, receive or digitally enhance chat messages for a user 116A-N via a user device 102A-N.

In one embodiment, the disclosed framework includes systems and processes for enhancing the web and its features with augmented reality. Example components of the framework can include:
Browser (mobile browser, mobile app, web browser, etc.)
Servers and namespaces the host (e.g., host server 100 can host the servers and namespaces. The content (e.g, VOBs, any other digital object), applications running on, with, or integrated with the disclosed platform can be created by others (e.g., third party content provider 112, promotions content server 114 and/or application publisher/developers 108A-N, etc.).
Advertising system (e.g., the host server 100 can run an advertisement/promotions engine through the platform and any or all deployed augmented reality, alternate reality, mixed reality or virtual reality environments)
Commerce (e.g., the host server 100 can facilitate transactions in the network deployed via any or all deployed augmented reality, alternate reality, mixed reality or virtual reality environments and receive a cut. A digital token or digital currency (e.g., crypto currency) specific to the platform hosted by the host server 100 can also be provided or made available to users.)
Search and discovery (e.g., the host server 100 can facilitate search, discovery or search in the network deployed via any or all deployed augmented reality, alternate reality, mixed reality or virtual reality environments)
Identities and relationships (e.g., the host server 100 can facilitate social activities, track identifies, manage, monitor, track and record activities and relationships between users 116A).

Functions and techniques performed by the host server 100 and the components therein are described in detail with further references to the examples of FIG. 3A-3B.

In general, network 106, over which the client devices 102A-N, the host server 100, and/or various application publisher/provider 108A-N, content server/provider 112, and/or promotional content server 114 communicate, may be a cellular network, a telephonic network, an open network, such as the Internet, or a private network, such as an intranet and/or the extranet, or any combination thereof. For example, the Internet can provide file transfer, remote log in, email, news, RSS, cloud-based services, instant messaging, visual voicemail, push mail, VoIP, and other services through any known or convenient protocol, such as, but is not limited to the TCP/IP protocol, Open System Interconnections (OSI), FTP, UPnP, iSCSI, NSF, ISDN, PDH, RS-232, SDH, SONET, etc.

The network 106 can be any collection of distinct networks operating wholly or partially in conjunction to provide connectivity to the client devices 102A-N and the host server 100 and may appear as one or more networks to the serviced systems and devices. In one embodiment, communications to and from the client devices 102A-N can be achieved by an open network, such as the Internet, or a private network, such as an intranet and/or the extranet. In one embodiment, communications can be achieved by a secure communications protocol, such as secure sockets layer (SSL), or transport layer security (TLS).

In addition, communications can be achieved via one or more networks, such as, but are not limited to, one or more of WiMax, a Local Area Network (LAN), Wireless Local Area Network (WLAN), a Personal area network (PAN), a Campus area network (CAN), a Metropolitan area network (MAN), a Wide area network (WAN), a Wireless wide area network (WWAN), enabled with technologies such as, by way of example, Global System for Mobile Communications (GSM), Personal Communications Service (PCS), Digital Advanced Mobile Phone Service (D-Amps), Bluetooth, Wi-Fi, Fixed Wireless Data, 2G, 2.5G, 3G, 4G, 5G, IMT-Advanced, pre-4G, 3G LTE, 3GPP LTE, LTE Advanced, mobile WiMax, WiMax 2, WirelessMAN-Advanced networks, enhanced data rates for GSM evolution (EDGE), General packet radio service (GPRS), enhanced GPRS, iBurst, UMTS, HSPDA, HSUPA, HSPA, UMTS-TDD, 1xRTT, EV-DO, messaging protocols such as, TCP/IP, SMS, MMS, extensible messaging and presence protocol (XMPP), real time messaging protocol (RTMP), instant messaging and presence protocol (IMPP), instant messaging, USSD, IRC, or any other wireless data networks or messaging protocols.

The host server 100 may include internally or be externally coupled to a user repository 128, a virtual object repository 130, a virtual item repository 126, a chat stream repository 124, an AR storgy repository 122 and/or a VR background repository 132. The repositories can store software, descriptive data, images, system information, drivers, and/or any other data item utilized by other components of the host server 100 and/or any other servers for operation. The repositories may be managed by a database management system (DBMS), for example but not limited to, Oracle, DB2, Microsoft Access, Microsoft SQL Server, PostgreSQL, MySQL, FileMaker, etc.

The repositories can be implemented via object-oriented technology and/or via text files, and can be managed by a distributed database management system, an object-oriented database management system (OODBMS) (e.g., ConceptBase, FastDB Main Memory Database Management System, JDOInstruments, ObjectDB, etc.), an object-relational database management system (ORDBMS) (e.g., Informix, OpenLink Virtuoso, VMDS, etc.), a file system, and/or any other convenient or known database management package.

In some embodiments, the host server 100 is able to generate, create and/or provide data to be stored in the user repository 128, the virtual object (VOB) repository 130, the virtual item 126, the chat stream repository 124, the AR story repository 122 and/or the VR background repository 132. The user repository 128 can store user information, user profile information, demographics information, analytics, statistics regarding human users, user interaction, brands advertisers, virtual object (or ‘VOBs’), access of VOBs, usage statistics of VOBs, ROI of VOBs, etc.

The virtual object repository 130 can store virtual objects and any or all copies of virtual objects. The VOB repository 130 can store virtual content or VOBs that can be retrieved for consumption in a target environment, where the virtual content or VOBs are contextually relevant. The VOB repository 130 can also include data which can be used to generate (e.g., generated in part or in whole by the host server 100 and/or locally at a client device 102A-N) contextually-relevant or aware virtual content or VOB(s).

The VR background repository 132 can store images, videos, photos or other media for use in a background to depict chat messages, chat bubbles and/or chat streams. The VR background repository 132 can store content or digital media and/or corresponding indicia that can be retrieved for depiction, reproduction or presentation or mixing into a AR environment. The VR background repository 132 can also include data which can be used to generate (e.g., generated in part or in whole by the host server 100 and/or locally at a client device 102A-N) or reproduce VR backgrounds.

The AR story repository 122 can store identifications of the number of layers or sublayers, identifiers for the BR layers or sublayers and/or rendering metadata of each given BR layer and/or sublayer for the host server 100 or client device 102A-N to render, create or generate or present the BR layer/sublayers.

The chat stream repository 124 can store chat messages, chat streams, virtual items rendered and generated in a communication in the AR environment.

The virtual item repository 126 can store various collections of virtual items which each includes multiple virtual objects added by any given user or users 116A-N.

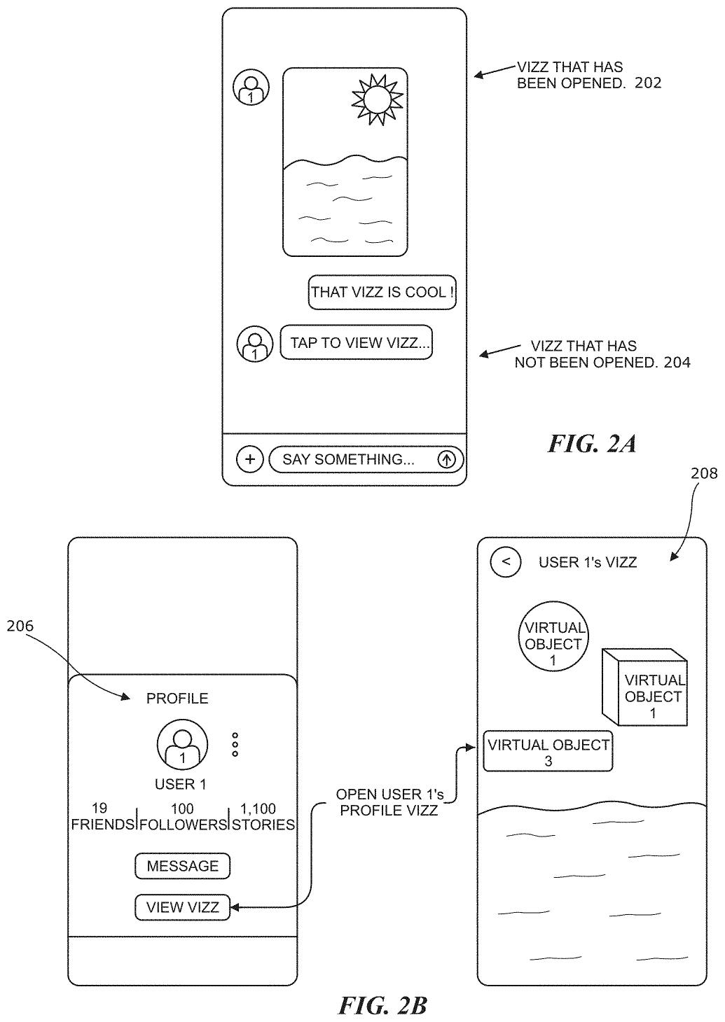

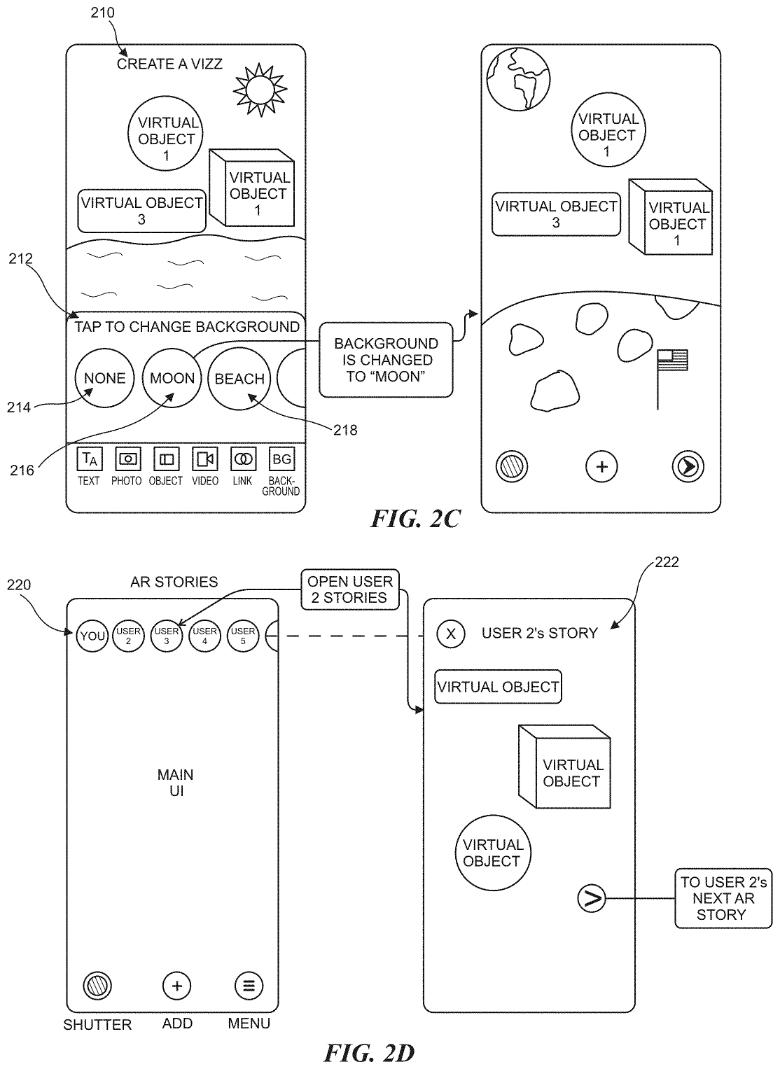

FIG. 2A depicts an example of a user interface of a chat stream showing thumbnails 202 for chat bubbles that have been accessed, in accordance with embodiments of the present disclosure.

In an AR chat stream, a virtual object or virtual item having a chat bubble can be depicted or rendered as a box 204 which can prompt a recipient to open tie virtual item. Once the virtual item has been opened, it can be depicted in the chat stream as a thumbnail 202 of the virtual item (e.g., ‘vizz’)

FIG. 2B depicts an example of a user interface of a profile virtual object 206 and a virtual item 208 (e.g., a ‘vizz’) having multiple virtual objects, in accordance with embodiments of the present disclosure.

For example, the profile virtual object 206 includes a user profile for user 1. The profile virtual object 206 can include digital, virtual reality and/or augmented reality features. The profile object 206 can also indicate a number of friends, followers, and/or a number of stores the user has published for consumption by others.

The profile virtual object 206 can also provide features for the user to create or send a message to another user. In one embodiment, the profile virtual object 206 also enables user 1 to view, open, access and/or modify their virtual items. For example, when a given virtual item is accessed, it can be opened as in 208. The multiple virtual objects (e.g., virtual object 1, virtual object 2, and virtual object 3) can be depicted. Each of the virtual objects in virtual item 208 can also be deleted, modified or interacted with.

FIG. 2C depicts an example of a user interface of showing indicators associated with virtual reality backgrounds 214, 216, 218 in a tool belt 212 in the AR environment, in accordance with embodiments of the present disclosure.

A user can create or modify a virtual item in user interface 210. The user interface 210 can include the tool belt 212, for example, having multiple indicates (214, 216, and 218, etc.) each associated with different VR backgrounds. If a given indicator is selected (for example, indicator 216 associated with the ‘moon’ background), the background of a virtual item can be changed.

FIG. 2D depicts an example of a further user interface of an augmented reality (AR) story object 220, in accordance with embodiments of the present disclosure.

The AR story object 220 can include multiple virtual items each associated with different users of the AR environment (e.g., user 2, user 3, user 4 . . . etc.). For example, each of the virtual items depicted in the AR story object 220 can be presented in chronological order based on a time when they were created or generated or published by the respective users. The stories 222 can be opened such that the virtual objects in any given item is depicted for access or interaction with.

FIG. 3A depicts an example functional block diagram of a host server 300 that administers a chat session in an AR environment, in accordance with embodiments of the present disclosure.

The host server 300 includes a network interface 302, a chat session manager 310, an AR story object manager 340, a profile virtual object generator 350 and/or a transition engine 360. The host server 300 is also coupled to an AR story repository 322, a chat stream repository 324 and/or a virtual item repository 326. Each of the chat session manager 310, the AR story object manager 340, the profile virtual object generator 350 and/or the transition engine 360. can be coupled to each other.

One embodiment of the chat session manager 310 includes, AR chat stream manager 312, thumbnail generator 314 and/or virtual item generator 318. One embodiment of the AR story object manager 340 includes, an AR story rendering engine 342 and/or a sequencing engine 344.

Additional or less modules can be included without deviating from the techniques discussed in this disclosure. In addition, each module in the example of FIG. 3A can include any number and combination of sub-modules, and systems, implemented with any combination of hardware and/or software modules.

The host server 300, although illustrated as comprised of distributed components (physically distributed and/or functionally distributed), could be implemented as a collective element. In some embodiments, some or all of the modules, and/or the functions represented by each of the modules can be combined in any convenient or known manner. Furthermore, the functions represented by the modules can be implemented individually or in any combination thereof, partially or wholly, in hardware, software, or a combination of hardware and software.

The network interface 302 can be a networking module that enables the host server 300 to mediate data in a network with an entity that is external to the host server 300, through any known and/or convenient communications protocol supported by the host and the external entity. The network interface 302 can include one or more of a network adaptor card, a wireless network interface card (e.g., SMS interface, WiFi interface, interfaces for various generations of mobile communication standards including but not limited to 1G, 2G, 3G, 3.5G, 4G, LTE, 5G, etc.,), Bluetooth, a router, an access point, a wireless router, a switch, a multilayer switch, a protocol converter, a gateway, a bridge, bridge router, a hub, a digital media receiver, and/or a repeater.

As used herein, a “module,” a “manager,” an “agent,” a “tracker,” a “handler,” a “detector,” an “interface,” or an “engine” includes a general purpose, dedicated or shared processor and, typically, firmware or software modules that are executed by the processor. Depending upon implementation-specific or other considerations, the module, manager, tracker, agent, handler, or engine can be centralized or have its functionality distributed in part or in full. The module, manager, tracker, agent, handler, or engine can include general or special purpose hardware, firmware, or software embodied in a computer-readable (storage) medium for execution by the processor.

As used herein, a computer-readable medium or computer-readable storage medium is intended to include all mediums that are statutory (e.g., in the United States, under 35 U.S.C. 101), and to specifically exclude all mediums that are non-statutory in nature to the extent that the exclusion is necessary for a claim that includes the computer-readable (storage) medium to be valid. Known statutory computer-readable mediums include hardware (e.g., registers, random access memory (RAM), non-volatile (NV) storage, flash, optical storage, to name a few), but may or may not be limited to hardware.

One embodiment of the host server 300 includes the chat session manager 310 having, the AR chat stream manager 312, the thumbnail generator 314 and/or the virtual item generator/adjustor 318. The chat session manager 310 can be any combination of software agents and/or hardware modules (e.g., including processors and/or memory units) able to manage, present, depict, generate, render, store, administer chat sessions among two users of the AR environment, or among any number of users in the AR environment. The AR chat stream manager 312 is able to track, generate, create, modify, manage an AR chat stream. For example, the AR chat stream manager 312 can track or detect interaction with or generation of chat bubbles. The AR chat stream manager 312 can also initiate or terminate sessions of chat among users in the AR environment. The thumb nail generator 314 can create, render or generate a thumb nail for a given virtual item (e.g., created by the virtual item generator 318). The thumb nail 314 can then be depicted once the virtual item has been accessed or opened.

One embodiment of the host server 300 further includes the AR story object manager 340 having an AR story rendering engine 342, and/or sequencing engine 344. The AR story object manager 340 can be any combination of software agents and/or hardware modules (e.g., including processors and/or memory units) able to manage, present, depict, generate, render, store, retrieve, adjust, display AR story objects (or, reality objects) showing a sequence of virtual items depicted based on when they were created by various users.

One embodiment of the host server 300 further includes the profile virtual object generator 350. The AR storgy object manager 340 can be any combination of software agents and/or hardware modules (e.g., including processors and/or memory units) able to manage, present, depict, generate, render, store, retrieve, adjust, display profile virtual objects which correspond to or include profile virtual objects which can include the user profile of a given user.

As a further example, the host server 300 (e.g., via the transition engine 360) can render BR as being selectively perceptible (e.g., transparent, opaque or translucent.) In this manner, the virtual objects can become more perceptible. For instance, the host server 300 can adjust perceptibility of the virtual objects (e.g., the virtual world and virtual content) of the scene to be more perceptible until it becomes the foreground and the basic reality objects (e.g., live, streaming or recorded image or video) is gone or almost gone. And system can can go in the other direction.

FIG. 3B depicts an example block diagram illustrating the components of the host server 300 that administers a chat session in an AR environment, in accordance with embodiments of the present disclosure.

In one embodiment, host server 300 includes a network interface 302, a processing unit 334, a memory unit 336, a storage unit 338, a location sensor 340, and/or a timing module 342. Additional or less units or modules may be included. The host server 300 can be any combination of hardware components and/or software agents to administer a chat session in an AR environment. The network interface 302 has been described in the example of FIG. 3A.

One embodiment of the host server 300 includes a processing unit 334. The data received from the network interface 302, location sensor 340, and/or the timing module 342 can be input to a processing unit 334. The location sensor 340 can include GPS receivers, RF transceiver, an optical rangefinder, etc. The timing module 342 can include an internal clock, a connection to a time server (via NTP), an atomic clock, a GPS master clock, etc.

The processing unit 334 can include one or more processors, CPUs, microcontrollers, FPGAs, ASICs, DSPs, or any combination of the above. Data that is input to the host server 300 can be processed by the processing unit 334 and output to a display and/or output via a wired or wireless connection to an external device, such as a mobile phone, a portable device, a host or server computer by way of a communications component.

One embodiment of the host server 300 includes a memory unit 336 and a storage unit 338. The memory unit 335 and a storage unit 338 are, in some embodiments, coupled to the processing unit 334. The memory unit can include volatile and/or non-volatile memory. The processing unit 334 may perform one or more processes related to administering or managing a chat session in an AR environment.

In some embodiments, any portion of or all of the functions described of the various example modules in the host server 300 of the example of FIG. 3A can be performed by the processing unit 334.

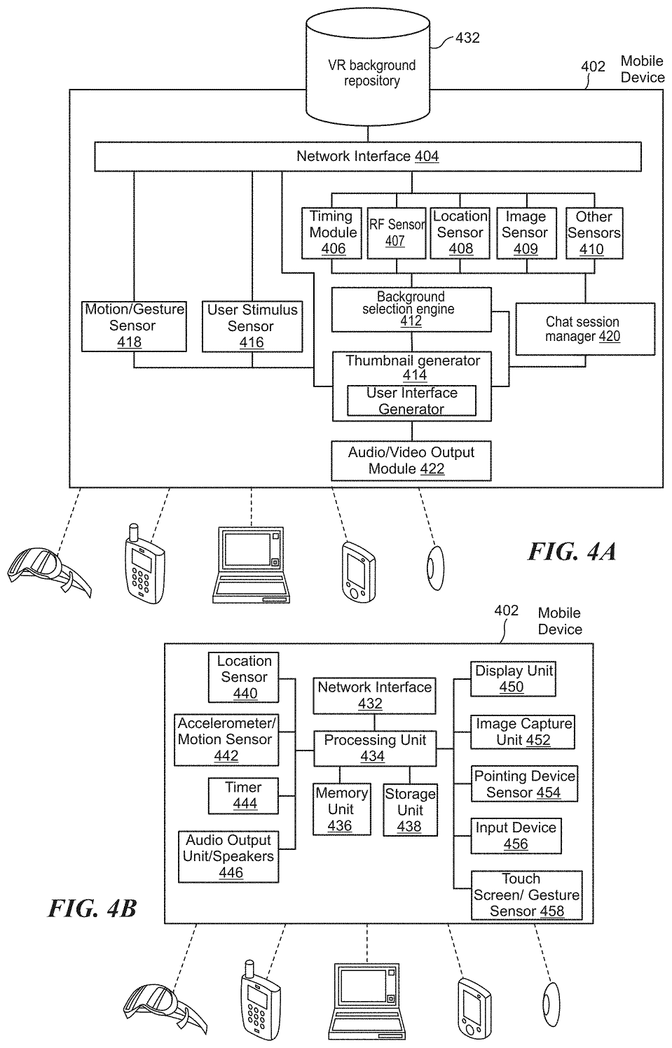

FIG. 4A depicts an example functional block diagram of a client device 402 such as a mobile device that enables participations in a chat session in an AR environment, in accordance with embodiments of the present disclosure

The client device 402 includes a network interface 404, a timing module 406, an RF sensor 407, a location sensor 408, an image sensor 409, a background selection engine 412, a thumbnail generator 414, a user stimulus sensor 416, a motion/gesture sensor 418, a chat session manager 420, an audio/video output module 422, and/or other sensors 410. The client device 402 may be any electronic device such as the devices described in conjunction with the client devices 102A-N in the example of FIG. 1 including but not limited to portable devices, a computer, a server, location-aware devices, mobile phones, PDAs, laptops, palmtops, iPhones, cover headsets, heads-up displays, helmet mounted display, head-mounted display, scanned-beam display, smart lens, monocles, smart glasses/goggles, wearable computer such as mobile enabled watches or eyewear, and/or any other mobile interfaces and viewing devices, etc.

In one embodiment, the client device 402 is coupled to a VR background repository 432. The VR background repository 432 may be internal to or coupled to the mobile device 402 but the contents stored therein can be further described with reference to the example of the VR background repository 132 described in the example of FIG. 1.

Additional or less modules can be included without deviating from the novel art of this disclosure. In addition, each module in the example of FIG. 4A can include any number and combination of sub-modules, and systems, implemented with any combination of hardware and/or software modules.

The client device 402, although illustrated as comprised of distributed components (physically distributed and/or functionally distributed), could be implemented as a collective element. In some embodiments, some or all of the modules, and/or the functions represented by each of the modules can be combined in any convenient or known manner. Furthermore, the functions represented by the modules can be implemented individually or in any combination thereof, partially or wholly, in hardware, software, or a combination of hardware and software.

In the example of FIG. 4A, the network interface 404 can be a networking device that enables the client device 402 to mediate data in a network with an entity that is external to the host server, through any known and/or convenient communications protocol supported by the host and the external entity. The network interface 404 can include one or more of a network adapter card, a wireless network interface card, a router, an access point, a wireless router, a switch, a multilayer switch, a protocol converter, a gateway, a bridge, bridge router, a hub, a digital media receiver, and/or a repeater.

According to the embodiments disclosed herein, the client device 402 can enable participations in a chat session in an AR environment.

The client device 402 can provide functionalities described herein via a consumer client application (app) (e.g., consumer app, client app. Etc.).The consumer application includes a user interface that enables access to the chat, opening or otherwise interacting with a chat message through virtual items or virtual objects.

FIG. 4B depicts an example block diagram of the client device 402, which can be a mobile device that enables participations in a chat session in an AR environment, in accordance with embodiments of the present disclosure.

In one embodiment, client device 402 (e.g., a user device) includes a network interface 432, a processing unit 434, a memory unit 436, a storage unit 438, a location sensor 440, an accelerometer/motion sensor 442, an audio output unit/speakers 446, a display unit 450, an image capture unit 452, a pointing device/sensor 454, an input device 456, and/or a touch screen sensor 458. Additional or less units or modules may be included. The client device 402 can be any combination of hardware components and/or software agents for enabling participations in a chat session in an AR environment. The network interface 432 has been described in the example of FIG. 4A.

One embodiment of the client device 402 further includes a processing unit 434. The location sensor 440, accelerometer/motion sensor 442, and timer 444 have been described with reference to the example of FIG. 4A.

The processing unit 434 can include one or more processors, CPUs, microcontrollers, FPGAs, ASICs, DSPs, or any combination of the above. Data that is input to the client device 402 for example, via the image capture unit 452, pointing device/sensor 454, input device 456 (e.g., keyboard), and/or the touch screen sensor 458 can be processed by the processing unit 434 and output to the display unit 450, audio output unit/speakers 446 and/or output via a wired or wireless connection to an external device, such as a host or server computer that generates and controls access to simulated objects by way of a communications component.

One embodiment of the client device 402 further includes a memory unit 436 and a storage unit 438. The memory unit 436 and a storage unit 438 are, in some embodiments, coupled to the processing unit 434. The memory unit can include volatile and/or non-volatile memory. In rendering or presenting an augmented reality environment, the processing unit 434 can perform one or more processes related to administering a chat session in an AR environment.

In some embodiments, any portion of or all of the functions described of the various example modules in the client device 402 of the example of FIG. 4A can be performed by the processing unit 434. In particular, with reference to the mobile device illustrated in FIG. 4A, various sensors and/or modules can be performed via any of the combinations of modules in the control subsystem that are not illustrated, including, but not limited to, the processing unit 434 and/or the memory unit 436.

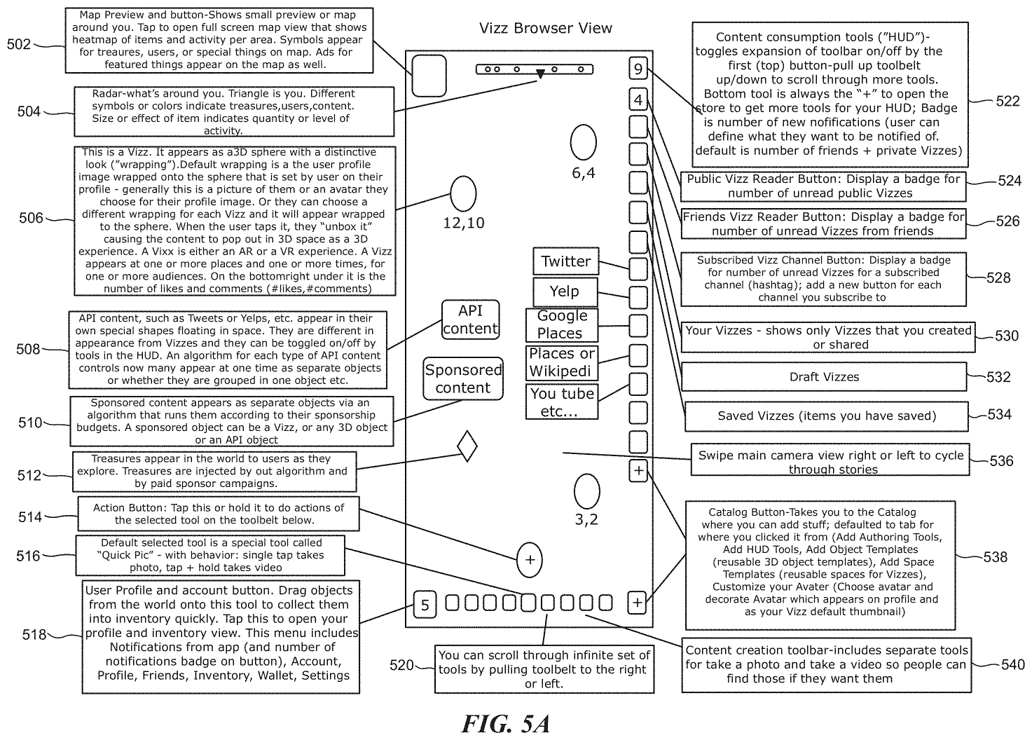

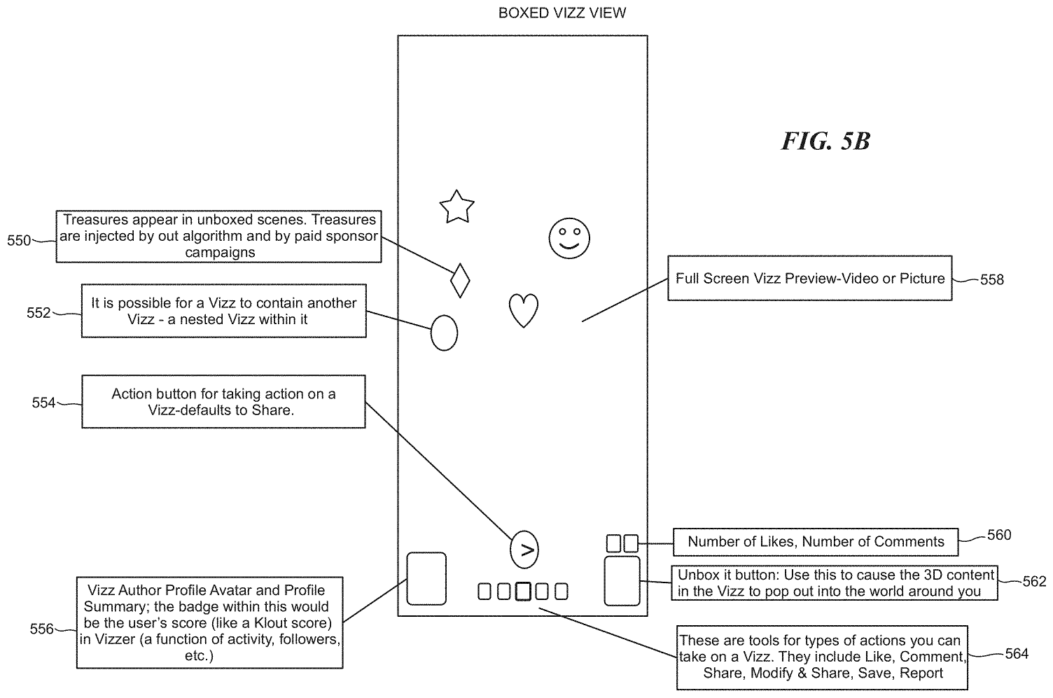

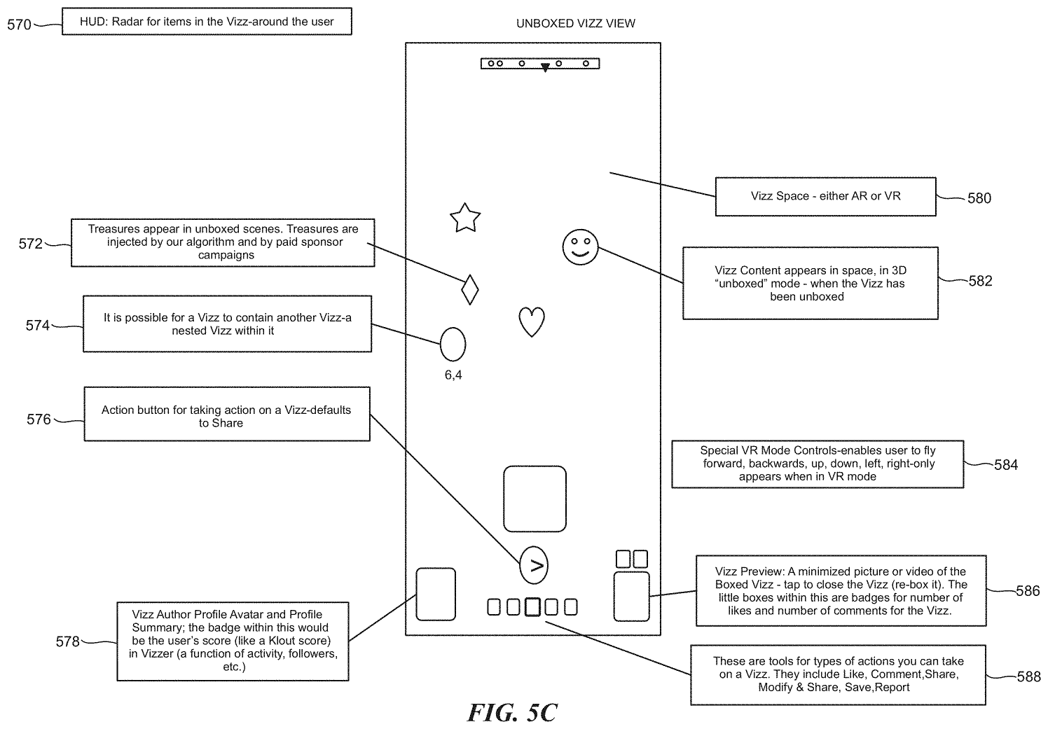

FIG. 5A graphically depicts a diagrammatic example of an application browser view to access virtual items, in accordance with embodiments of the present disclosure.

Item 502 depicts a map preview and a button which can show a small preview of map around a user. It can be tapped to open full screen map view that shows heat map of items and activity per area. Symbols can appear for treasures, users, or special things on map. Ads for featured things can be depicted on the map as well.

Item 504 depicts a radar which shows what is around a user. Different symbols or colors can be used to indicate treasures, users, content. Size or effect of item can indicate quantity or level of activity.

Item 506 includes a virtual item. The virtual item can appear as a 3D sphere with a distinctive look (“wrapping”). Default wrapping is a the user profile image wrapped onto the sphere that is set by user on their profile—generally this is a picture of them or an avatar they choose for their profile image. Or they can choose a different wrapping for each Vizz and it will appear wrapped to the sphere. When the user taps it, they “unbox it” causing the content to pop out in 3D space as a 3D experience. A Vizz is either an AR or a VR experience. A Vizz appears at one or more places and one or more times, for one or more audiences. On the bottom right under it is the number of likes and comments (# likes, # comments).

Item 508 can in one embodiment, depict API content, such as Tweets or Yelps, etc. appear in their own special shapes floating in space. They can be different in appearance from Vizzes and they can be toggled on/off by tools in the HUD. An algorithm for each type of API content controls how many appear at one time as separate objects or whether they are grouped in one object etc.

Item 510 can include sponsored content which can appear as separate objects via an algorithm that runs them according to their sponsorship budgets. A sponsored object can be a Vizz, or any 3D object, or an API object. Item 512 can depict treasures which appear in the world to users as they explore. Treasures can be injected by the system and/or by paid sponsor campaigns.

Item 514 depicts an Action Button: Tap this or hold it to do actions of the selected tool on the tool belt below. Item 516 depicts Default selected tool is a special tool called “Quick Pic”—with behavior: single tap takes photo, tap+hold takes video. Item 518 can depict a User Profile and account button. Users can Drag objects from the world onto this tool to collect them into inventory quickly. User can Tap this to open your profile and inventory view. This menu can include Notifications from app (and number of notifications badge on button), Account, Profile, Friends, Inventory, Wallet, Settings.

Item 520 includes a tool belt. A user can scroll through infinite set of tools by pulling the tool belt to the right or left. Item 522 depicts a Content consumption tools (“HUD”) which toggles expansion of toolbar on/off by the first (top) button—pull up tool belt up/down to scroll through more tools. Bottom tool can be the “+” to open the store to get more tools for your HUD; Badge is number of new notifications (user can define what they want to be notified of, default is number of friends+private virtual items (e.g., Vizzes)).

Item 524 depicts a Public Vizz Reader Button: Display a badge for number of unread public Vizzes. Item 526 depicts a Friends Vizz Reader Button: Display a badge for number of unread Vizzes from friends. Item 528 depicts a Subscribed Vizz Channel Button: Display a badge for number of unread Vizzes for a subscribed channel (hashtag); add a new button for each channel you subscribe to. Item 530 depicts Your Vizzes—which can shows only Vizzes that you created or shared. Item 532 can depict draft Vizzes. Item 534 can depict saved Vizzes. Item 536 can allow a Swipe of the main camera view right or left to cycle through stories.

Item 538 can include a Catalog Button—which can Takes you to the Catalog where you can add items or objects; defaulted to tab for where you clicked it from (Add Authoring Tools, Add HUD Tools, Add Object Templates (reusable 3D object templates), Add Space Templates (reusable spaces for Vizzes), Customize your Avatar (Choose avatar and decorate Avatar which appears on profile and as your Vizz default thumbnail). Item 540 can include a Content creation toolbar—Includes separate tools for take a photo and take a video so people can find those if they want them.

FIG. 5B-5C graphically depict diagrammatic examples of a virtual item in the AR environment, in accordance with embodiments of the present disclosure.

Item 550 can include Treasures that appear in unboxed scenes. Treasures are injected by the system and by paid sponsor campaigns. Item 552 depicts a Vizz which includes another Vizz—a nested Vizz within it. Item 554 depicts Action button for taking action on a Vizz—defaults to Share. Item 556 depicts a Vizz Author Profile Avatar and Profile Summary; the badge within this would be the user's score (like a Klout score) in Vizzer (a function of activity, followers, etc.).

Item 558 depicts a Full Screen Vizz Preview—Video or Picture. Item 560 depicts Number of Likes, Number of Comments. Item 562 depicts an Unbox it button: Use this to cause the 3D content in the Vizz to pop out into the world around you. Item 564 depicts various tools for types of actions you can take on a Vizz. They include Like, Comment, Share, Modify & Share, Save, Report.

Item 570 depicts HUD: Radar for items in the Vizz—around the user. Item 580 depicts a Vizz Space—either AR or VR. Item 582 depicts Vizz Content which appears in space, in 3D “unboxed” mode—when the Vizz has been unboxed. Item 584 depicts Special VR Mode Controls—which enables user to fly forward, backwards, up, down, left, right—only appears when in VR mode. Item 586 depicts a Vizz Preview: A minimized picture or video of the Boxed Vizz—tap to close the Vizz (re-box it). The little boxes within this are badges for number of likes and number of comments for the Vizz. Item 588 includes tools for types of actions you can take on a Vizz. They include Like, Comment, Share, Modify & Share, Save, Report

FIG. 6A-6B graphically depict multidimensional user interfaces for facilitating user interaction, in accordance with embodiments of the present disclosure.

In user interface 602, the 3D toggle is switched on relative to user interface 604. When the 3D toggle is on, users can add or create 3D or augmented reality features to create a virtual item or virtual object. The virtual items can be sent to other users as a message or published as an AR story for example. User interface 608 depicts an example of a virtual item having a VR background.

User interface 610 depicts an example of a chat stream showing thumb nails for chat bubbles that have been accessed or opened. User interface 612 depicts an example of a virtual item that is opened or ‘unboxed.’ User interface 614 depicts an example of an AR story object corresponding to a given location. For example, in discovery mode, the user can see or access all stories published by friends or certain sets of users currently in or relevant to a given location. User interface 616 shows an example of a VR story that has been opened.

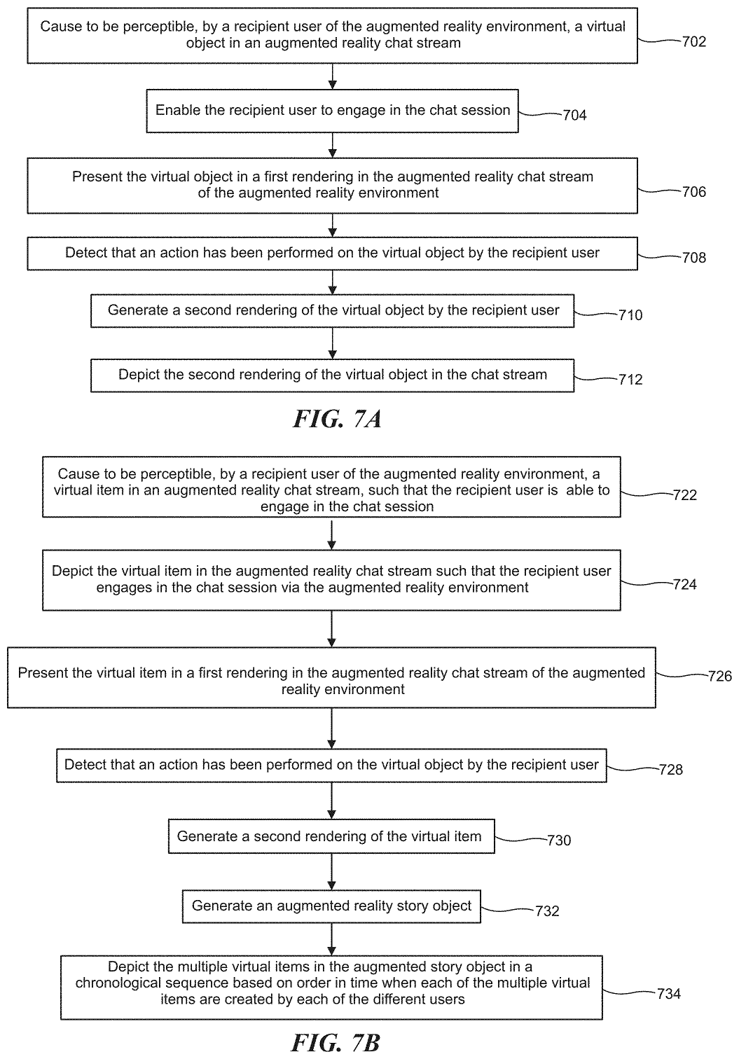

FIG. 7A-7B depict flow charts illustrating an example process to render an AR chat stream in the AR environment, in accordance with embodiments of the present disclosure.

In process 702, a virtual object is caused to be perceptible, by a recipient user of the augmented reality environment in an augmented reality chat stream. In one embodiment, the virtual object can be shared with the recipient user by another entity that uses the augmented reality environment. In process 704, the recipient user is enabled to engage in the chat session. In process 706, the virtual object is presented in a first rendering in the augmented reality chat stream of the augmented reality environment.

In process 708, it is detected that an action has been performed on the virtual object by the recipient user. In process 710, a second rendering of the virtual object is generated. In process 712, the second rendering of the virtual object is depicted in the chat stream.

In one embodiment the virtual object includes a chat bubble. The first rendering of the virtual object can include a first indicia and the second rendering of the virtual object can include a second indicia. In one embodiment, the second indicia includes a thumbnail of the virtual object. The thumbnail can be sent with the virtual object to the recipient user from the other entity.

One embodiment, further includes, detecting a request of the other entity in the augmented reality environment and creating the virtual object to include a message to be shared by the other entity with the recipient user. One embodiment further includes creating a profile virtual object to represent the recipient user in the augmented reality environment. The profile virtual object can, for example include a user profile of the recipient user rendered in 3D. Access to the profile virtual object can be enabled via the augmented reality environment. The recipient user can also delete or replace the profile virtual object via the augmented reality environment.

In a further embodiment, access to a collection of virtual objects associated with the recipient user is enabled or provided in the augmented reality environment via the profile virtual object. The access to the collection of the virtual objects associated with the recipient user can also be provided to the other user or additional users of the augmented reality environment. The access to the collection of the virtual objects associated with the recipient user can also be provided to the recipient user.

In process 722, a virtual item is caused to be perceptible, by a recipient user of the augmented reality environment, in an augmented reality chat stream, such that the recipient user is able to engage in the chat session. The virtual item can include one or more virtual objects. The virtual item can, for example, be shared with the recipient user by another user that uses the augmented reality environment. In process 724, the virtual item is depicted in the augmented reality chat stream such that the recipient user engages in the chat session via the augmented reality environment

In process 726, the virtual item is presented in a first rendering in the augmented reality chat stream of the augmented reality environment. In process 728, it is detected that an action has been performed on the virtual object by the recipient user.

In process 730, a second rendering of the virtual item is generated. In process 732, an augmented reality story object is generated. In process 734, the multiple virtual items are depicted in the augmented story object in a chronological sequence based on an order in time when each of the multiple virtual items are created by each of the different users.

One embodiment includes, generating a virtual reality background and presenting an indicator of the virtual reality background in a tool belt in the augmented reality environment. Selection of the virtual reality background via activation of the indicator is detected. In one embodiment, in response to detection of selection of the virtual reality background via activation of the indicator, the virtual reality background can be rendered in the augmented reality environment in which the one or more virtual objects of the virtual item is depicted.

The one or more virtual objects of the virtual item are rendered in a foreground of the virtual reality environment. The one or more virtual objects of the virtual item are rendered in a foreground of the virtual reality environment. Note that the one or more virtual objects can be added to the virtual item by the other user. In one embodiment, an augmented reality story object is generated. The AR story object can include, for example, multiple virtual items. In some instances, each of the multiple virtual items can be created by different users of the augmented reality environment. In one embodiment, the multiple virtual items are depicted in the augmented story object in a chronological sequence based on an order in time when each of the multiple virtual items are created by each of the different users.

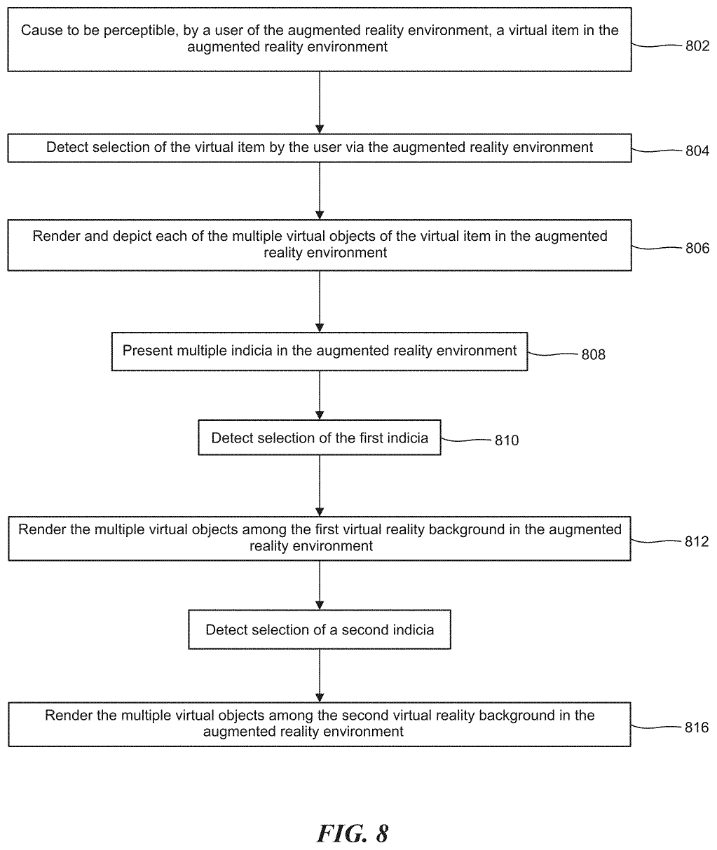

FIG. 8 depicts a flow chart illustrating an example process to change the virtual reality background among which multiple virtual objects are depicted, in accordance with embodiments of the present disclosure.

In process 802, a virtual item is caused to be perceptible in an AR environment, by a user of the augmented reality environment. The virtual item can include multiple virtual objects. The multiple virtual objects can also be added to the virtual item responsive to requests of the user.

In process 804, a selection of the virtual item by the user via the augmented reality environment is detected. In process 806, each of the multiple virtual objects of the virtual item are rendered and depicted in the augmented reality environment. In process 808, multiple indicia are presented in the augmented reality environment. A first indicia of the multiple indicia can be associated with a first virtual reality background

In process 810, selection of the first indicia is detected. In process 812, the multiple virtual objects are rendered among the first virtual reality background in the augmented reality environment. In process 814, selection of a second indicia is detected. The second indicia of the multiple indicia can be associated with a second virtual reality background. In process 816, the multiple virtual objects are rendered among the second virtual reality background in the augmented reality environment.

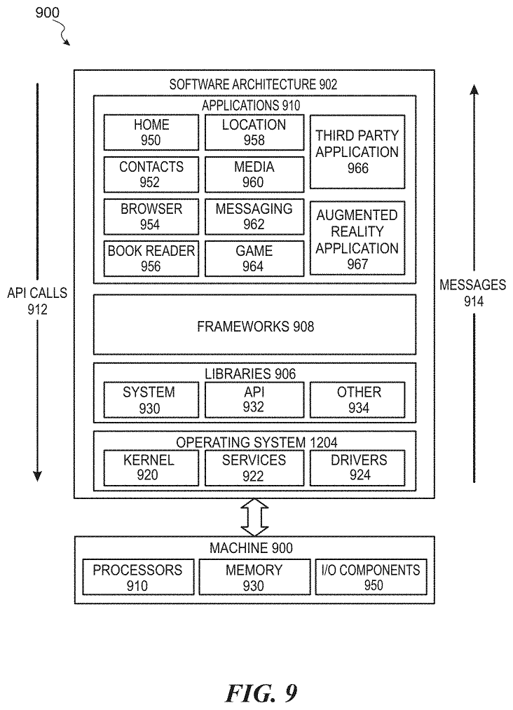

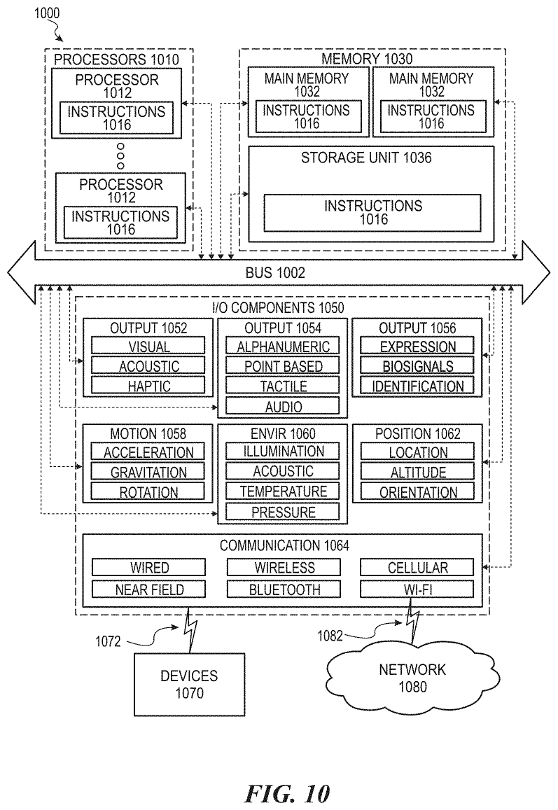

FIG. 9 is a block diagram 900 illustrating an architecture of software 902, which can be installed on any one or more of the devices described above. FIG. 9 is a non-limiting example of a software architecture, and it will be appreciated that many other architectures can be implemented to facilitate the functionality described herein. In various embodiments, the software 902 is implemented by hardware such as machine 1000 of FIG. 10 that includes processors 1010, memory 1030, and input/output (I/O) components 1050. In this example architecture, the software 902 can be conceptualized as a stack of layers where each layer may provide a particular functionality. For example, the software 902 includes layers such as an operating system 904, libraries 1106, frameworks 908, and applications 910. Operationally, the applications 910 invoke API calls 912 through the software stack and receive messages 914 in response to the API calls 912, in accordance with some embodiments.

In some embodiments, the operating system 904 manages hardware resources and provides common services. The operating system 904 includes, for example, a kernel 920, services 922, and drivers 924. The kernel 920 acts as an abstraction layer between the hardware and the other software layers consistent with some embodiments. For example, the kernel 920 provides memory management, processor management (e.g., scheduling), component management, networking, and security settings, among other functionality. The services 922 can provide other common services for the other software layers. The drivers 924 are responsible for controlling or interfacing with the underlying hardware, according to some embodiments. For instance, the drivers 924 can include display drivers, camera drivers, BLUETOOTH drivers, flash memory drivers, serial communication drivers (e.g., Universal Serial Bus (USB) drivers), WI-FI drivers, audio drivers, power management drivers, and so forth.

In some embodiments, the libraries 906 provide a low-level common infrastructure utilized by the applications 910. The libraries 906 can include system libraries 930 (e.g., C standard library) that can provide functions such as memory allocation functions, string manipulation functions, mathematics functions, and the like. In addition, the libraries 906 can include API libraries 932 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 906 can also include a wide variety of other libraries 934 to provide many other APIs to the applications 910.

The frameworks 908 provide a high-level common infrastructure that can be utilized by the applications 910, according to some embodiments. For example, the frameworks 908 provide various graphic user interface (GUI) functions, high-level resource management, high-level location services, and so forth. The frameworks 908 can provide a broad spectrum of other APIs that can be utilized by the applications 910, some of which may be specific to a particular operating system 904 or platform.

In an example embodiment, the applications 910 include a home application 950, a contacts application 952, a browser application 954, a search/discovery application 956, a location application 958, a media application 960, a messaging application 962, a game application 964, and other applications such as a third party application 966. According to some embodiments, the applications 910 are programs that execute functions defined in the programs. Various programming languages can be employed to create one or more of the applications 910, structured in a variety of manners, such as object-oriented programming languages (e.g., Objective-C, Java, or C++) or procedural programming languages (e.g., C or assembly language). In a specific example, the third party application 966 (e.g., an application developed using the Android, Windows or iOS. software development kit (SDK) by an entity other than the vendor of the particular platform) may be mobile software running on a mobile operating system such as Android, Windows or iOS, or another mobile operating systems. In this example, the third party application 966 can invoke the API calls 912 provided by the operating system 904 to facilitate functionality described herein.

An augmented reality application 967 may implement any system or method described herein, including integration of augmented, alternate, virtual and/or mixed realities for digital experience enhancement, or any other operation described herein.

FIG. 10 is a block diagram illustrating components of a machine 1000, according to some example embodiments, able to read a set of instructions from a machine-readable medium (e.g., a machine-readable storage medium) and perform any one or more of the methodologies discussed herein.

Specifically, FIG. 10 shows a diagrammatic representation of the machine 1000 in the example form of a computer system, within which instructions 1016 (e.g., software, a program, an application, an applet, an app, or other executable code) for causing the machine 1000 to perform any one or more of the methodologies discussed herein can be executed. Additionally, or alternatively, the instruction can implement any module of FIG. 3A and any module of FIG. 4A, and so forth. The instructions transform the general, non-programmed machine into a particular machine programmed to carry out the described and illustrated functions in the manner described.

In alternative embodiments, the machine 1000 operates as a standalone device or can be coupled (e.g., networked) to other machines. In a networked deployment, the machine 1000 may operate in the capacity of a server machine or a client machine in a server-client network environment, or as a peer machine in a peer-to-peer (or distributed) network environment. The machine 1000 can comprise, but not be limited to, a server computer, a client computer, a PC, a tablet computer, a laptop computer, a netbook, a set-top box (STB), a PDA, an entertainment media system, a cellular telephone, a smart phone, a mobile device, a wearable device (e.g., a smart watch), a head mounted device, a smart lens, goggles, smart glasses, a smart home device (e.g., a smart appliance), other smart devices, a web appliance, a network router, a network switch, a network bridge, a Blackberry, a processor, a telephone, a web appliance, a console, a hand-held console, a (hand-held) gaming device, a music player, any portable, mobile, hand-held device or any device or machine capable of executing the instructions 1016, sequentially or otherwise, that specify actions to be taken by the machine 1000. Further, while only a single machine 1000 is illustrated, the term “machine” shall also be taken to include a collection of machines 1000 that individually or jointly execute the instructions 1016 to perform any one or more of the methodologies discussed herein.

The machine 1000 can include processors 1010, memory/storage 1030, and I/O components 1050, which can be configured to communicate with each other such as via a bus 1002. In an example embodiment, the processors 1010 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) can include, for example, processor 1012 and processor 1014 that may execute instructions 1016. The term “processor” is intended to include multi-core processor that may comprise two or more independent processors (sometimes referred to as “cores”) that can execute instructions contemporaneously. Although FIG. 10 shows multiple processors, the machine 1000 may include a single processor with a single core, a single processor with multiple cores (e.g., a multi-core processor), multiple processors with a single core, multiple processors with multiples cores, or any combination thereof

The memory/storage 1030 can include a main memory 1032, a static memory 1034, or other memory storage, and a storage unit 1036, both accessible to the processors 1010 such as via the bus 1002. The storage unit 1036 and memory 1032 store the instructions 1016 embodying any one or more of the methodologies or functions described herein. The instructions 1016 can also reside, completely or partially, within the memory 1032, within the storage unit 1036, within at least one of the processors 1010 (e.g., within the processor's cache memory), or any suitable combination thereof, during execution thereof by the machine 1000. Accordingly, the memory 1032, the storage unit 1036, and the memory of the processors 1010 are examples of machine-readable media.

As used herein, the term “machine-readable medium” or “machine-readable storage medium” means a device able to store instructions and data temporarily or permanently and may include, but is not be limited to, random-access memory (RAM), read-only memory (ROM), buffer memory, flash memory, optical media, magnetic media, cache memory, other types of storage (e.g., Erasable Programmable Read-Only Memory (EEPROM)) or any suitable combination thereof The term “machine-readable medium” or “machine-readable storage medium” should be taken to include a single medium or multiple media (e.g., a centralized or distributed database, or associated caches and servers) able to store instructions 1016. The term “machine-readable medium” or “machine-readable storage medium” shall also be taken to include any medium, or combination of multiple media, that is capable of storing, encoding or carrying a set of instructions (e.g., instructions 1016) for execution by a machine (e.g., machine 1000), such that the instructions, when executed by one or more processors of the machine 1000 (e.g., processors 1010), cause the machine 1000 to perform any one or more of the methodologies described herein. Accordingly, a “machine-readable medium” or “machine-readable storage medium” refers to a single storage apparatus or device, as well as “cloud-based” storage systems or storage networks that include multiple storage apparatus or devices. The term “machine-readable medium” or “machine-readable storage medium” excludes signals per se.

In general, the routines executed to implement the embodiments of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Further examples of machine-readable storage media, machine-readable media, or computer-readable (storage) media include, but are not limited to, recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

The I/O components 1050 can include a wide variety of components to receive input, provide output, produce output, transmit information, exchange information, capture measurements, and so on. The specific I/O components 1050 that are included in a particular machine will depend on the type of machine. For example, portable machines such as mobile phones will likely include a touch input device or other such input mechanisms, while a headless server machine will likely not include such a touch input device. It will be appreciated that the I/O components 1050 can include many other components that are not shown in FIG. 10. The I/O components 1050 are grouped according to functionality merely for simplifying the following discussion and the grouping is in no way limiting. In example embodiments, the I/O components 1050 can include output components 1052 and input components 1054. The output components 1052 can include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1054 can include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instruments), tactile input components (e.g., a physical button, a touch screen that provides location and force of touches or touch gestures, or other tactile input components), audio input components (e.g., a microphone), eye trackers, and the like.

In further example embodiments, the I/O components 1052 can include biometric components 1056, motion components 1058, environmental components 1060, or position components 1062 among a wide array of other components. For example, the biometric components 1056 can include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 1058 can include acceleration sensor components (e.g., an accelerometer), gravitation sensor components, rotation sensor components (e.g., a gyroscope), and so forth. The environmental components 1060 can include, for example, illumination sensor components (e.g., a photometer), temperature sensor components (e.g., one or more thermometers that detect ambient temperature), humidity sensor components, pressure sensor components (e.g., a barometer), acoustic sensor components (e.g., one or more microphones that detect background noise), proximity sensor components (e.g., infrared sensors that detect nearby objects), gas sensor components (e.g., machine olfaction detection sensors, gas detection sensors to detect concentrations of hazardous gases for safety or to measure pollutants in the atmosphere), or other components that may provide indications, measurements, or signals corresponding to a surrounding physical environment. The position components 1062 can include location sensor components (e.g., a GPS receiver component), altitude sensor components (e.g., altimeters or barometers that detect air pressure from which altitude may be derived), orientation sensor components (e.g., magnetometers), and the like.

Communication can be implemented using a wide variety of technologies. The I/O components 1050 may include communication components 1064 operable to couple the machine 1000 to a network 1080 or devices 1070 via a coupling 1082 and a coupling 1072, respectively. For example, the communication components 1064 include a network interface component or other suitable device to interface with the network 1080. In further examples, communication components 1064 include wired communication components, wireless communication components, cellular communication components, Near Field Communication (NFC) components, Bluetooth. components (e.g., Bluetooth. Low Energy), WI-FI components, and other communication components to provide communication via other modalities. The devices 1070 may be another machine or any of a wide variety of peripheral devices (e.g., a peripheral device coupled via a USB).

The network interface component can include one or more of a network adapter card, a wireless network interface card, a router, an access point, a wireless router, a switch, a multilayer switch, a protocol converter, a gateway, a bridge, bridge router, a hub, a digital media receiver, and/or a repeater.

The network interface component can include a firewall which can, in some embodiments, govern and/or manage permission to access/proxy data in a computer network, and track varying levels of trust between different machines and/or applications. The firewall can be any number of modules having any combination of hardware and/or software components able to enforce a predetermined set of access rights between a particular set of machines and applications, machines and machines, and/or applications and applications, for example, to regulate the flow of traffic and resource sharing between these varying entities. The firewall may additionally manage and/or have access to an access control list which details permissions including for example, the access and operation rights of an object by an individual, a machine, and/or an application, and the circumstances under which the permission rights stand.

Other network security functions can be performed or included in the functions of the firewall, can be, for example, but are not limited to, intrusion-prevention, intrusion detection, next-generation firewall, personal firewall, etc. without deviating from the novel art of this disclosure.

Moreover, the communication components 1064 can detect identifiers or include components operable to detect identifiers. For example, the communication components 1064 can include Radio Frequency Identification (RFID) tag reader components, NFC smart tag detection components, optical reader components (e.g., an optical sensor to detect one-dimensional bar codes such as a Universal Product Code (UPC) bar code, multi-dimensional bar codes such as a Quick Response (QR) code, Aztec Code, Data Matrix, Dataglyph, MaxiCode, PDF417, Ultra Code, Uniform Commercial Code Reduced Space Symbology (UCC RSS)-2D bar codes, and other optical codes), acoustic detection components (e.g., microphones to identify tagged audio signals), or any suitable combination thereof. In addition, a variety of information can be derived via the communication components 1064, such as location via Internet Protocol (IP) geo-location, location via WI-FI signal triangulation, location via detecting a BLUETOOTH or NFC beacon signal that may indicate a particular location, and so forth.

In various example embodiments, one or more portions of the network 1080 can be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a WI-FI® network, another type of network, or a combination of two or more such networks. For example, the network 1080 or a portion of the network 1080 may include a wireless or cellular network, and the coupling 1082 may be a Code Division Multiple Access (CDMA) connection, a Global System for Mobile communications (GSM) connection, or other type of cellular or wireless coupling. In this example, the coupling 1082 can implement any of a variety of types of data transfer technology, such as Single Carrier Radio Transmission Technology, Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, 5G, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 1016 can be transmitted or received over the network 1080 using a transmission medium via a network interface device (e.g., a network interface component included in the communication components 1064) and utilizing any one of a number of transfer protocols (e.g., HTTP). Similarly, the instructions 1016 can be transmitted or received using a transmission medium via the coupling 1072 (e.g., a peer-to-peer coupling) to devices 1070. The term “transmission medium” shall be taken to include any intangible medium that is capable of storing, encoding, or carrying the instructions 1016 for execution by the machine 1000, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the innovative subject matter has been described with reference to specific example embodiments, various modifications and changes may be made to these embodiments without departing from the broader scope of embodiments of the present disclosure. Such embodiments of the novel subject matter may be referred to herein, individually or collectively, by the term “innovation” merely for convenience and without intending to voluntarily limit the scope of this application to any single disclosure or novel or innovative concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of embodiments of the disclosure is not intended to be exhaustive or to limit the teachings to the precise form disclosed above. While specific embodiments of, and examples for, the disclosure are described above for illustrative purposes, various equivalent modifications are possible within the scope of the disclosure, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times. Further, any specific numbers noted herein are only examples: alternative implementations may employ differing values or ranges.

The teachings of the disclosure provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further embodiments of the disclosure.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

While certain aspects of the disclosure are presented below in certain claim forms, the inventors contemplate the various aspects of the disclosure in any number of claim forms. For example, while only one aspect of the disclosure is recited as a means-plus-function claim under 35 U.S.C. §112, ¶6, other aspects may likewise be embodied as a means-plus-function claim, or in other forms, such as being embodied in a computer-readable medium. (Any claims intended to be treated under 35 U.S.C. §112, ¶6 will begin with the words “means for”.) Accordingly, the applicant reserves the right to add additional claims after filing the application to pursue such additional claim forms for other aspects of the disclosure.

What is claimed is:

1. A method to administer a chat session in an augmented reality environment, the method, comprising:
causing to be perceptible, by a recipient user of the augmented reality environment, a virtual object in an augmented reality chat stream, such that the recipient user is able to engage in the chat session;
wherein, the virtual object is shared with the recipient user by another entity that uses the augmented reality environment;
wherein, the virtual object is depicted in the augmented reality chat stream such that the recipient user engages in the chat session via the augmented reality environment;
wherein the virtual object is presented in a first rendering in the augmented reality chat stream of the augmented reality environment;
responsive to detecting that an action has been performed on the virtual object by the recipient user, generating a second rendering of the virtual object;
depicting the second rendering of the virtual object in the chat stream.

2. The method of claim 1, wherein:
further wherein, the first rendering of the virtual object includes a first indicia;
the second rendering of the virtual object includes a second indicia.

3. The method of claim 2, wherein:
the second indicia includes a thumbnail of the virtual object.

4. The method of claim 3, wherein:
the thumbnail is sent with the virtual object to the recipient user from the other entity.

5. The method of claim 1, wherein:
the virtual object includes a chat bubble.

6. The method of claim 1, further comprising:
detecting a request of the other entity in the augmented reality environment;
creating the virtual object to include a message to be shared by the other entity with the recipient user.

7. The method of claim 1, further comprising:
creating a profile virtual object to represent the recipient user in the augmented reality environment;
wherein, the profile virtual object includes a user profile of the recipient user rendered in 3D.

8. The method of claim 7, further comprising:
enabling access to the profile virtual object via the augmented reality environment.

9. The method of claim 7, further comprising:
enabling the recipient user to delete the profile virtual object via the augmented reality environment.

10. The method of claim 7, further comprising:
enabling the recipient user to replace the profile virtual object via the augmented reality environment.

11. The method of claim 7, further comprising:
enabling access to a collection of virtual objects associated with the recipient user in the augmented reality environment via the profile virtual object.

12. The method of claim 11, wherein:
the access to the collection of the virtual objects associated with the recipient user is provided to the other user or additional users of the augmented reality environment.

13. The method of claim 11, wherein:
the access to the collection of the virtual objects associated with the recipient user is provided to the recipient user.

14. A method to administer a chat session in an augmented reality environment, the method, comprising:
causing to be perceptible, by a recipient user of the augmented reality environment, a virtual item in an augmented reality chat stream, such that the recipient user is able to engage in the chat session;
wherein, the virtual item includes one or more virtual objects;
wherein, the virtual item is shared with the recipient user by another user that uses the augmented reality environment;
wherein, the virtual item is depicted in the augmented reality chat stream such that the recipient user engages in the chat session via the augmented reality environment;
wherein the virtual item is presented in a first rendering in the augmented reality chat stream of the augmented reality environment;
responsive to detecting that an action has been performed on the virtual object by the recipient user, generating a second rendering of the virtual item;
depicting the second rendering of the virtual item in the chat stream.

15. The method of claim 14, further comprising:
generating a virtual reality background;
presenting an indicator of the virtual reality background in a tool belt in the augmented reality environment;
detecting selection of the virtual reality background via activation of the indicator.

16. The method of claim 15, further comprising:
responsive to detection of selection of the virtual reality background via activation of the indicator, rendering the virtual reality background in the augmented reality environment in which the one or more virtual objects of the virtual item is depicted;
wherein, the one or more virtual objects of the virtual item are rendered in a foreground of the virtual reality environment.

17. The method of claim 14, wherein:
the one or more virtual objects are added to the virtual item by the other user.

18. The method of claim 14, further comprising:
generating an augmented reality story object;
wherein, the augmented reality story object includes multiple virtual items;
wherein, each of the multiple virtual items are created by different users of the augmented reality environment.

19. The method of claim 18, further comprising:
depicting the multiple virtual items in the augmented story object in a chronological sequence based on an order in time when each of the multiple virtual items are created by each of the different users.

20. A machine-readable storage medium, having stored thereon instructions, which when executed by a processor, cause the processor to implement a method, to administer a virtual item in an augmented reality environment of a real world environment, the method, comprising:
causing to be perceptible, by a user of the augmented reality environment, a virtual item in the augmented reality environment;
wherein, the virtual item includes multiple virtual objects;
wherein, the multiple virtual objects are added to the virtual item responsive to requests of the user;
detecting selection of the virtual item by the user via the augmented reality environment;
rendering and depicting each of the multiple virtual objects of the virtual item in the augmented reality environment;
wherein, each of the multiple virtual objects are individually accessible for interaction by the user via the augmented reality environment;
presenting multiple indicia in the augmented reality environment;
wherein, a first indicia of the multiple indicia is associated with a first virtual reality background;
in response to detection of selection of the first indicia;
rendering the multiple virtual objects among the first virtual reality background in the augmented reality environment;
in response to detection of selection of a second indicia;
wherein, a second indicia of the multiple indicia is associated with a second virtual reality background;
rendering the multiple virtual objects among the second virtual reality background in the augmented reality environment.
